(19) United States
(12) Patent Application Publication
(10) Pub. No.: US 2024/0084117 A1
(43) Pub. Date: Mar. 14, 2024

(54) PROPYLENE/ETHYLENE RANDOM COPOLYMER-BASED RESIN

(71) Applicant: ESENTTIA S.A., Cartagena (CO)

(72) Inventors: Rodney Alfonso CARDONA CABARCAS, Cartagena (CO); Enrique Giovanny MOGOLLÓN RINCÓN, Cartagena (CO); Andrea del Pilar MORALES PARDO, Bogotá (CO); Carlos Mauricio TORRES SILVA, Bogotá (CO)

(21) Appl. No.: 18/261,316

(22) PCT Filed: Nov. 22, 2021
(86) PCT No.: PCT/IB2021/060832

§ 371 Date: Jul. 13, 2023

(30) Foreign Application Priority Data
Jan. 13, 2021 (CO) NC2021/0000198

(51) Int. Cl. C08L 23/14

(52) U.S. Cl. CPC C08L 23/142; C08L 2205/025

(57) ABSTRACT

The present invention relates to a polypropylene resin comprising a propylene/ethylene copolymer; an elastomer as impact modifier based on polypropylene or polyethylene and additives. The resin of the present disclosure is characterized by a flow index between 2 g/10 min to 10 g/10 min measured at 230° C.; density between 0.89 kg/m3 and 0.91 kg/m³; elongation percentage between 11% and 15%; flexural modulus between 792.9 MPa to 1034.2 MPa; tensile strength between 24.13 MPa and 27.58 MPa and Izod impact between 210 J/m and 350 J/m, making it useful in the manufacture of a wide range of products for the food, automotive, nautical, chemical, furniture and equipment, household appliances and sporting goods industries, among others.

### FIELD OF THE INVENTION

The development is related to the field of engineering materials, particularly to a propylene/ethylene resin with improved mechanical and processability properties for the manufacture of polymeric products by injection molding or similar processes, ensuring functionality in the relevant application.

### DESCRIPTION OF THE PRIOR ART

Polypropylene-based resins have been widely used in various industrial fields due to their excellent performance and cost-effectiveness due to their various properties, which include a wide range of flow rates, medium to high melting point, high tensile strength, excellent stiffness, chemical resistance and at the same time, they have excellent molding, recycling, and heat resistance properties, which makes them suitable for mitigating environmental problems. Considering these properties, polypropylene resins can generally be processed by injection, extrusion, blow molding or similar methods to obtain products used in a wide variety of applications such as automotive, food, household appliances and a wide range of industrial products.

However, conventional or single-component polypropylene-based resins can sometimes become brittle with deformation and have low impact strength, which may be insufficient for the balance required for various applications. In addition, the tensile strength and viscoelasticity of polypropylene melt are often low, limiting applications to thermoforming molding or other similar methods. Particularly, conventional polypropylene-based resins have poor non-Newtonian behavior and low swelling index, which generates flow marks on the molded article resulting in a deteriorated appearance of the product. In order to overcome these problems, in particular to improve the impact resistance and elongation at break of polypropylene resins one of the alternatives used are the addition of impact copolymers or also polypropylene based resins employing various types of polymer blends.

For example, U.S. Pat. No. 8,324,335 discloses a composition comprising a propylene/ethylene copolymer (Z component), between 50 wt % to 99.9 wt %, and a propylene polymer (M component) in an amount of 0.1 wt % to 50 wt %, and as an impact modifier a propylene-based polymer (M component) in an amount of between 0.1 wt % to 50 wt %. In particular, the Z-component is a propylene/ethylene copolymer obtained by sequential production by a multi-stage polymerization method of a crystalline propylene polymer and a random propylene/ethylene copolymer using a conventional catalyst, which is called a propylene/ethylene block copolymer. The M-component used as a modifier is a propylene/ethylene copolymer, wherein a part of the crystalline propylene polymer segment and the amorphous propylene copolymer segment are chemically bonded, so that the M-component has a branched structure with the amorphous propylene copolymer segment as the main chain and with the crystalline propylene polymer segment as the side chain. The main chain and side chain components may contain in addition to propylene and ethylene, other unsaturated compounds, e.g., an α-olefin such as 1-butene, as well as the use of other additives between 0.0001 to 5 parts by weight of the composition.

Similarly, patent U.S. Pat. No. 7,915,359 discloses a propylene resin composition comprising 60 wt to 95 wt % of a crystalline propylene polymer comprising a propylene homopolymer or a propylene copolymer and up to 3 wt % of ethylene or an α-olefin having 4-20 carbon atoms (component a) and, 40 wt % to 5 wt % of a propylene/ethylene copolymer (component b), wherein the components are polymerized using a metallocene catalyst. Component b comprises at least two types of propylene/ethylene copolymers (b-1) and (b-2), wherein, the ethylene content of ingredient b-1 is from 15 wt % to 30 wt % and the ethylene content of ingredient b-2 is from 40 wt % to 55 wt % and wherein, the ratio of the amount of ingredient b-1 to ingredient b-2 is in the range of 1:99 to 40:60. Additionally, the composition includes additives between 0.0001 wt % to 3 wt % to improve the performance of the polypropylene resin.

On the other hand, patent U.S. Pat. No. 6,825,280 discloses a polypropylene polymer comprising a polypropylene block copolymer consisting of blocks a and b and having a flow rate 0.1 g/10 min to 200 g/10 min. Particularly, block a is a polymeric block of a propylene homopolymer or a random copolymer of propylene with a comonomer selected from the group consisting of ethylene and C₄-C₂₀ α-olefins, and wherein the content of the comonomer is less than 10% by mole. Block b is a polymer block of a random copolymer of propylene with at least one comonomer selected from the group consisting of ethylene and C₄-C₂₀ α-olefins, wherein the content of the comonomer is from 10% to 80% by mole, the average chain length of the comonomer block and the raw average chain length of the comonomer have a ratio represented by Formula (I):

n_{b}≈n+1.5 (I)

Wherein n_{b} represents the average chain length of the comonomer block and n represents the raw average chain length of the comonomer. Additionally, the resin composition further contains an inorganic filler agent, an elastomer and in some cases a polypropylene resin produced in the presence of a Ziegler catalyst and/or a polypropylene modified with unsaturated carboxylic acid.

However, while these polypropylene-based resin compositions are sufficient for many applications, in some other applications they have insufficient effect to meet requirements, requiring the use of complex blends of different components or expensive production methods. The use of blends improves some properties, but also impairs other desirable mechanical or physicochemical properties of polypropylene resins, so there is still a need to develop alternative polypropylene-based resins to achieve the balance of stiffness, impact strength, tensile elongation, breaking strength, etc.

In addition to the final properties described above, it is important for the manufactured materials to have good processability in the corresponding transformation processes, which must be taken into account in the selection of components, especially in the case of mixtures.

### BRIEF DESCRIPTION OF THE INVENTION

In a first aspect, the present disclosure refers to a polypropylene resin comprising a propylene/ethylene co-polymer between 85% to 98% by weight (w/w); an elastomer as an impact modifier based on polypropylene or polyethylene between 1% w/w to 14% w/w and additives between 1% w/w to 2% w/w useful in the manufacture of various products of industrial interest by thermoforming molding processes or other similar methods.

In a second aspect, the present disclosure refers to a polypropylene resin characterized by a flow index between 2 g/10 min to 10 g/10 min measured at 230° C.; density between 0.89 kg/m³ and 0.91 kg/m³; elongation percentage between 11% and 15%; flexural modulus between 792.9 MPa to 1034.2 MPa; tensile strength between 24.13 MPa and 27.58 MPa and Izod impact at 23° C. between 210 J/m and 350 J/m.

In a third aspect, the present disclosure refers to the use of polypropylene-based resin in the manufacture of parts and products for the food, automotive, nautical, chemical, furniture and equipment, household appliances and sporting goods industries, among others.

### BRIEF DESCRIPTION OF THE FIGURES

FIG. 1. Weight of linerless caps made from C₂, C₃, C₄ and commercial high-density polyethylene (HDPE) resins.

FIG. 2. Application angle of linerless caps made from C₂, C₃, C₄ and commercial high-density polyethylene (HDPE) resins.

FIG. 3. Dimensional parameters of linerless-type cap.

FIG. 4. Dimensional tests for red and white linerless caps made from C₄ resin and linerless cap with commercial high-density polyethylene (HDPE) resin: (A) Outside diameter; (B) Height; (C) Bottom thickness; and (D) Weight.

FIG. 5. Functional tests for red and white linerless caps made from C₄ resin and linerless cap with commercial high-density polyethylene (HDPE) resin: (A) removal torque; (B) angle of application; and (C) carbonatation.

### DETAILED DESCRIPTION

For purposes of interpreting this description, the following definitions shall apply and where appropriate, terms used in the singular form shall also include the plural form.

The terms used in the description have the meanings normally given to them in the technical field unless this description or the context clearly indicates otherwise.

The present disclosure corresponds to a polypropylene-based resin with improved mechanical and processability properties for the manufacture of polymeric products by injection molding processes or the like. Particularly, the polypropylene resin of the present disclosure comprises at least a mixture between a propylene/ethylene copolymer and an elastomer as impact modifier based on polypropylene or polyethylene, which provide the resin with a substantial improvement in impact resistance, guaranteeing the balance between fluidity index, stiffness, tensile elongation, breaking strength, chemical resistance and excellent molding, recycling, and heat resistance properties, among others.

Unless otherwise indicated, implicitly from the context or customary in the art, all parts and percentages in the present description are based on weight.

For the purposes of the present disclosure, “polypropylene resin” means those compositions based on homopolymers and copolymers of polypropylene used alone or in combination in order to improve the physical and chemical properties of propylene. In particular, polypropylene is a thermoplastic polymer produced from propylene monomers (propene) of general formula —(C₃H₆)ₙ—, whereby polypropylene produced solely from propylene monomers corresponds to a propylene homopolymer, where the polypropylene molecules are composed of a chain of vinyl groups —(CH₂)— from which methyl groups —(CH₃) are detached, which can be all on the same side of the chain (isotactic polypropylene), alternated on one or the other side of the chain (syndiotactic polypropylene) or indistinctly alternated on both sides of the chain (atactic polypropylene).

However, if during the polymerization reaction of propylene another monomer other than propylene is added, e.g., ethylene or butylene, polypropylene copolymers are obtained. When the chains of both monomers alternate randomly, random polypropylene copolymers are obtained, but if the chains of both monomers are arranged in homogeneous blocks a chain of one monomer followed by a chain of the other monomer, block polypropylene copolymers are obtained. The physical and chemical properties, including the mechanical properties and behavior during molding processes and the in-use performance of polypropylene resins depend greatly on the chemical structure of the polypropylene-based polymers used in the resin.

According to the present disclosure, the polypropylene resin comprises a propylene/ethylene copolymer, an elastomer as an impact modifier based on polypropylene or polyethylene and additives. In particular, the propylene/ethylene copolymer of the present disclosure is a random copolymer wherein the ratio of propylene to ethylene is between 15.7:1 to 49:1, with intermediate ranges between 15.7:1 to 19:1, between 19:1 to 24:1, or between 24:1 to 32.3:3 or between 32.3:1 to 49:1.

The amount of the propylene/ethylene copolymer in the resin can vary depending on the desired mechanical properties and use requirements of the resin. For example, the amount of propylene/ethylene in the present invention can vary between 85% w/w to 99% w/w, with intermediate ranges between 85% w/w to 88% w/w, or between 88% w/w to 90.7% w/w, between 90.7% w/w to 93.4% w/w, between 93.4% w/w to 97% w/w, between 97% w/w to 98% w/w.

Moreover, the polypropylene resin comprises an elastomer as impact modifier based on polypropylene or polyethylene or mixtures thereof. The amount of the elastomer as impact modifier in the resin can vary depending on the desired mechanical properties and usage needs of the resin. For example, the amount of elastomer as an impact modifier in the present invention may vary between 0.2% w/w to 14% w/w, with intermediate ranges between 0.2% w/w to 0.5% w/w, or between 0.5% w/w to 1% w/w, between 1% w/w to 5% w/w, between 5% w/w to 10% w/w, between 10% w/w to 14% w/w.

For purposes of the present invention, when the impact-modifying elastomer is polypropylene based it corresponds to a copolymer of propylene and an α-olefin of 4 to carbon atoms such as 1-butene (butylene), 1-pentene, 1-hexene, 1-heptene and 1-octene. In one embodiment of the present disclosure the α-olefin is butylene or 1-pentene. For example, the polypropylene-based impact-modifying elastomer has a propylene to butylene ratio between 1.5:1 to 49:1, between 1.5:1 to 2.3:1, between 2.3:1 to 3.8:1, or between 3.8:1 to 7.7:1, or between 7.7:1 to 49:1.

In another mode of the present disclosure, when the impact-modifying elastomer is polyethylene based it corresponds to a copolymer of ethylene and an α-olefin of 4 to 20 carbon atoms such as 1-butene (butylene), 1-pentene, 1-hexene, 1-heptene and 1-octene. In a preferred embodiment of the present disclosure the α-olefin is butylene or 1-pentene. For example, the polyethylene-based impact-modifying elastomer has an ethylene to butylene ratio of from 4:1 to 49:1, between 4:1 to 5.5:1, between 5.5:1 to 8.1:1, or between 8.1:1 to 14.4:1 or between 14.4:1 to 49:1.

Particularly, the polypropylene resin is characterized in that the ratio of the propylene/ethylene copolymer and the polypropylene or polyethylene-based impact-modifying elastomer is between 6.1:1 to 98:1, with intermediate ranges between 6.1:1 to 8:1, between 8:1 to 11.3:1, or between 11.3:1 to 18.7:1, or between 18.7:1 to 98:1.

In another aspect, the polypropylene resin of the present disclosure further comprises additives. For purposes of the present disclosure the term “additive” refers to any substance that is incorporated to improve the properties of the material or to impart specific features to the material. Additives are selected, but not limited to antioxidants, acid acceptors, release agents, antistatic, nucleating agents, pigments, and mixtures thereof. Additives are found in polypropylene resin between 1% w/w to 2% w/w.

When the additives are antioxidants they are selected, but not limited to pentaerythritol tetrachis (3-(3,5-di-tert-butyl-4-hydroxyphenyl) propionate) with CAS number 6683-19-8, tris (4-tert-butyl-3-hydroxy-2,6-dimethylbenzyl) isocyanurate with CAS number 40601-76-1,1,3,5-tris (3,5-di-tert-butyl-4-hydroxybenzyl)-1,3,5-triazine-2,4,6 (1H, 3H, 3H, 5H)-trione with CAS number 27676-62-6,3,3′,3′,5,5′,5′-hexa-tert-butyl-A,A′,A′-(mesitylene-2,4,6-triyl) tri-p-cresol with CAS number 1709-70-2 and mixtures thereof. The amount of these antioxidants in the resin can be between 0.01% w/w to 0.15% w/w, depending on the type of antioxidant used.

Other antioxidants used, without being limited to these are tris(2,4-di-tert-butylphenyl) phosphite with CAS No. 31570-04-4, bis(2,4-dicumylphenyl) pentaerythritol diphosphite with CAS No. 154862-43-8, [4-[4-[4-bis(2,4-ditert-butylphenoxy)phosphanylphenyl]phenyl]-bis(2,4-ditert-butylphenoxy) phosphane with CAS No. 119345-01-6 and mixtures thereof. The number of antioxidants in the polypropylene resin of the present disclosure is, e.g., between 0.04% w/w to 0.15% w/w, depending on the specific type of additive used and the combination with the primary antioxidant.

When the additives are acid acceptors, they are selected, but not limited to calcium stearate with CAS number 1592-23-0, magnesium aluminum hydroxycarbonate with CAS number 11097-59-9, zinc oxide with CAS number 1314-13-2, sodium benzoate with CAS number 532-32-1 and mixtures thereof. The amount of acid acceptors in the polypropylene resin of the present disclosure is, e.g., between 0.02% w/w to 0.1% w/w, depending on the specific type of additive used and the primary and secondary antioxidants used in the formulation.

When the additives are release agents they are selected, but not limited to cis-13-docosenoamide and (Z) docos 13 enamide, both with CAS No. 112-84-5, oleamide with CAS No. 301-02-0, behenamide as CAS No. 3061-75-4 and mixtures thereof. The amount of release agents in the polypropylene resin of the present disclosure is, e.g., between 0.2% w/w to 0.9% w/w, depending on the type of additive or mixture used.

When the additives are antistatic, they are selected, but not limited to glyceryl monostearate with CAS number 31566-31-1, polyethylene glycol distearate with CAS number 9005-08-7, glycerol fatty acid ester with CAS number 85029-63-6, coco-bis(2-hydroxyethyl) amines with CAS number 61791-31-9, ethylene bistearamide with CAS number and mixtures thereof. The amount of antistatics in the polypropylene resin of the present disclosure is, e.g., between 0.1% w/w to 0.3% w/w.

When the additives are nucleating agents, they are selected, but not limited to sodium benzoate with CAS number 532-32-1, magnesium silicate hydrate with CAS number 14807-96-6, di(3,4-dimethylbenzylidene) sorbitol with CAS number 135861-56-2, lithium salt of 2,T-methylenebis(2,4-di-tert-butylphenyl) phosphate with CAS number 85209-93-4, hydroxy bis[2,2-methylenebis(4,6-di-tert-butylphenyl) aluminum phosphate with CAS number 151841-65-5 and mixtures thereof. The amount of nucleates in the polypropylene resin of the present disclosure is, e.g., between 0.03% w/w to 0.8% w/w, depending on the type of nucleating additive used. It is important to take into account the interactions of the additives used to ensure their effectiveness.

For purposes of the present disclosure, mixing of the components forming the polypropylene resin can be carried out by various methods known in the art including, but not limited to mixing in blenders followed by an extrusion process, or fed separately to the extrusion process. In a preferred embodiment, blending is accomplished by the single-screw or twin-screw extrusion process, in which the materials are melted through shear stresses generated by the screw(s) of the extruder machine and thereby the degree of blending of the propylene/ethylene copolymer resin and impact modifier is achieved. The temperature conditions of the extrusion process depend directly on the flow rate of the resin and the content of the impact modifier in the product formulation. Usually, these values are between 190° C. to 230° C.

The polypropylene resin of the present disclosure is presented in powder form at one stage of the process, but it is finally presented in pellet form since it is very sensitive to degradation in powder form without the addition of additives, thus affecting the properties of the resin. On the contrary, with the resin in pellet form, it is possible to feed the extruders of the transformation processes, for its subsequent molding into articles with complex shapes that require precision in their dimensions. The methods of molding the polypropylene resin of the present disclosure include, but are not limited to injection, compression, and calendering. In any case, the conditions of the molding method must be appropriately matched to ensure the desired properties of the material. In a preferred embodiment, the molding is performed by injection molding with temperature conditions ranging from 190° C. to 230° C., depending on the melt flow rate of the resin used.

The polypropylene resin of the present disclosure is characterized by a flow index between 2 g/10 min to 10 g/10 min measured at 230° C., density between 0.89 kg/m³ and 0.91 kg/m³, yield elongation between 11% and 15%, flexural modulus between 792.9 MPa to 1034.2 MPa, tensile strength between 24.13 MPa and 27.58 MPa, Izod impact at 23° C. between 210 J/m and 350 J/m. The properties of the present polypropylene resin depend on its components and their proportion.

The resin of the present disclosure is useful in the manufacture of articles by means of injection molding processes (e.g., caps, containers, thick rigid containers, auto parts, etc.), compression molding (lids, containers), thermoforming (sheets, rigid containers, cups, tubs, etc.), blown containers, among others.

In one embodiment, the propylene/ethylene random copolymer-based resin is useful in the manufacture of linerless type caps, where no liner or liner film is required on the cap to facilitate the sealing of the cap to the container used to ensure containment of carbonated (with the use of carbon dioxide dissolved in the liquid) and non-carbonated beverages. This application has been largely governed by materials such as high-density polyethylene (HDPE), but not by polypropylene formulations such as those of the present disclosure.

One of the advantages of polypropylene resins compared to polyethylene resins is that, given the greater rigidity of polypropylene, caps can be manufactured with a lower weight, guaranteeing the same or better functionality, which brings advantages in cost and promotes the lower use of material per application, reducing its environmental impact.

The present invention will be presented in detail through the following examples, which are provided for illustrative purposes only and not intended to limit its scope.

### Examples

### Example 1: Preparation of Propylene/Ethylene Random Copolymer-Based Resins

The propylene/ethylene random copolymer-based resin can be manufactured by means of a Ziegler/Natta type polymerization process in fluidized bed or stirred bed reactors or any other designed for this purpose, in gas phase in the presence of a titanium chloride catalyst with silica supports, magnesium chlorides among others. Moreover, to complete the catalytic complex, aluminum alkyls are used, in particular, triethyl aluminum (C₂H₅)₃Al and selectivity control agents, or external donor selected from cyclohexyl-methyl-dimethoxysilane, dicyclopentyl-dimethoxysilane, diisopropyl-dimethoxysilane, isobutyl(isopropyl)-dimethoxysilane, among others.

This process allows the manufacture of polymers of a molecular weight in direct proportion to the length of the chains produced with the catalytic complex under the conditions of temperature and pressure determined and controlled by means of the hydrogen feed, which allows obtaining certain molecular weights with a specific statistical distribution. The molecular weight distribution (MWD) is relevant because it confers to the polymer a good part of the processability properties and final features that determine its application.

In the manufacture of polypropylene resins, propylene must be fed as the main monomer, which makes it possible to form a polymer that reaches a higher molecular weight to the extent that it contains more propylene monomer units. When only propylene (propene, C₃H₆) is used as a monomer in the manufacturing process, a polypropylene homopolymer is obtained, which is characterized mainly by its rigidity and is therefore used mainly in applications that require this property, such as in the manufacture of rigid injection molded containers.

Other applications require a better balance between stiffness and impact and additionally improved optical properties, such as better transparency and gloss among others. In these cases, random and impact copolymers have better properties for such applications. In the case of random copolymers, in addition to propylene as the main monomer, other monomers (called comonomers) such as ethylene (ethene, C₂H₄), butene (C₄H₈), pentene (C₅H₁₀), among others, must be fed to the reactor. The incorporation of these comonomers is done randomly, according to the relationships controlled by the elements of the catalytic package and the operating conditions in the reactor. In this way, it is possible to control the manufacturing architecture of the resin based on random propylene/ethylene copolymer used to manufacture the product of the present disclosure.

### Example 2: Resins Based on Random Propylene/Ethylene Copolymer and Impact Modifiers

Polypropylene resins comprising propylene/ethylene copolymer and additives were prepared along with concentrations of impact-modifying elastomer based on a propylene/butylene copolymer. The prepared resin formulations A₁ through A₅ are described in detail in Tables 1 and 2.

TABLE 1
Formulations of polypropylene resins where the impact
modifier is a propylene-butylene copolymer.

| | | FORMULATION (% w/w) | | | |
|---|---|---|---|---|---|
| COMPONENT | | A₁ | A₂ | A₃ | A₄ |
| Polypropylene | Propylene/ethylene | 98.52 | 95.52 | 92.02 | 90.52 |
| resin | random copolymer | | | | |
| Impact modifier | Propylene/butylene | 0.5 | 3.5 | 7.0 | 8.5 |
| | elastomer | | | | |
| Primary | Tris (4-tert-butyl- | 0.02 | 0.04 | 0.01 | 0.015 |
| antioxidant | 3-hydroxy-2,6- | | | | |
| | dimethylbenzyl) | | | | |
| | isocyanurate | | | | |
| Secondary | Tris (2,4-di-di-tert- | 0.04 | 0.06 | 0.08 | 0.10 |
| antioxidant | butylphenyl) phosphite | | | | |
| Nucleating | Sodium benzoate | 0.2 | 0.15 | 0.25 | 0.3 |
| Acid acceptor | Magnesium aluminum | 0.03 | 0.02 | 0.04 | 0.05 |
| | hydroxide carbonate | | | | |
| Release agent | Oleamide | 0.03 | 0.06 | 0.08 | 0.15 |
| Release agent | cis-13-docosenoamide | 0.66 | 0.85 | 0.55 | 0.95 |
| Antistatic | Glyceryl monostearate | 0.20 | 0.15 | 0.35 | 0.1 |

Wherein in the random copolymer the ratio of propylene to ethylene 19:1 and the ratio of propylene to butylene in the impact-modifying elastomer is between 2.3:1.

Formulations of polypropylene resins where the impact modifier is a copolymer of propylene and butylene.

| | | FORMULATION |
|---|---|---|
| | | (% w/w) |
| COMPONENT | | A₅ |
| Polypropylene | Propylene/ethylene random | 88.02 |
| resin | copolymer | |
| Impact modifier | Propylene/butylene elastomer | 11 |
| Primary | Tris (4-tert-butyl-3-hydroxy-2,6- | 0.02 |
| antioxidant | dimethylbenzyl) isocyanurate | |
| Secondary | Tris (2,4-di-di-tert- | 0.04 |
| antioxidant | butylphenyl) phosphite | |
| Nucleating | Sodium benzoate | 0.2 |
| Acid acceptor. | Magnesium aluminum hydroxide | 0.03 |
| | carbonate | |
| Release agent | Oleamide | 0.03 |
| Release agent | (Z) -docos-13-enamide | 0.66 |

Wherein in the random copolymer the propylene to ethylene ratio is between 19:1 and the propylene to butylene ratio in the impact-modifying elastomer is between 2.3:1.

Additionally, polypropylene resins comprising propylene/ethylene copolymer and additives were prepared against increasing amounts of impact-modifying elastomer based on a copolymer of ethylene and butylene. The prepared resin formulations B₁ through B 5 are described in detail in Table 3.

Polypropylene resins where the impact modifier is a copolymer of ethylene and butylene.

| | | FORMULATION (% w/w) | | | | |
|---|---|---|---|---|---|---|
| | COMPONENT | B₁ | B₂ | B₃ | B₄ | B₅ |
| Polypropylene | Propylene/ethylene random | 98.52 | 95.52 | 92.02 | 90.52 | 88.02 |
| resin | copolymer | | | | | |
| Impact | Ethylene/butylene elastomer | 0.5 | 3.5 | 7.0 | 8.5 | 11.0 |
| modifier | | | | | | |
| Primary | Tris (4-tert-butyl-3-hydroxy-2,6- | 0.02 | 0.04 | 0.01 | 0.015 | 0.02 |
| antioxidant | dimethylbenzyl) isocyanurate | | | | | |
| Secondary | Tris (2,4-di-di-tert-butylphenyl) | 0.04 | 0.04 | 0.06 | 0.08 | 0.10 |
| antioxidant | phosphite | | | | | |
| Nucleating | Sodium benzoate | 0.2 | 0.15 | 0.25 | 0.30 | 0.22 |
| Acid acceptor. | Magnesium aluminum hydroxide | 0.03 | 0.02 | 0.04 | 0.05 | 0.03 |
| | carbonate | | | | | |
| Release agent | Oleamide | 0.03 | 0.03 | 0.03 | 0.03 | 0.03 |
| Release agent | cis-13-docosenoamide | 0.66 | 0.85 | 0.55 | 0.66 | 0.95 |
| Antistatic | Glyceryl monostearate | 0.20 | 0.15 | 0.35 | 0.1 | 0.1 |

Wherein in the random copolymer the propylene to ethylene ratio is between 19:1 and the ethylene to butylene ratio in the impact-modifying elastomer is between 5.5:1.

The different resins corresponding to A₁-A₅ and B₁-B₅ were subsequently subjected to an extrusion process by means of single or double screw extruders that generate sufficiently high shear stresses to melt the resins and additives and thus achieve homogenization between the components. In this process there are several stages that include feeding, mixing, melting, head pressing and finally pelletizing where, by means of a blade, the pellets that would be used for the transformation processes are formed. The pellets are then molded and tested to evaluate their mechanical properties and final performance in the application. During the extrusion process, it is particularly important to monitor the specific energy of the material in order to achieve the desired homogeneity among the components without generating an excess of energy that could degrade the material and affect its final properties. For this purpose, it is important to monitor the yellowing index, the color of the manufactured materials and the stability of the fluidity index of the formulations.

### Example 3: Characterization of Mechanical Properties of Polypropylene/Ethylene Random Copolymer-Based Resins

The resins corresponding to formulations A₁ to A₅ and B₁ to B₅ described in Example 2 were characterized according to the analyses in Table 4.

TABLE 4
Characterization tests for polypropylene/ethylene
random copolymer-based resins

| | TEST METHOD/ | |
|---|---|---|
| TEST | CONDITIONS | USED EQUIPMENT |
| Plate | Measurement of rheological | AR-G2 pan rotational |
| rheology | properties and molecular | rheometer |
| | weight distribution | |
| Melt flow | Determination of melt flow | Extrusion plastometer |
| | (ASTM D1238-04C) | Tinius Olsen |
| Deformation | Determination of tensile | Instron Model 3345 |
| | strength and elongation at | Universal Measuring |
| | maximum yield in | Instrument |
| | polypropylene. | |
| | (ASTM D638/03) | |
| Tensile | Determination of tensile | Instron Model 3345 |
| strength | strength and elongation at | Universal Measuring |
| (Tensile) | maximum yield in | Instrument |
| | polypropylene. | |
| | (ASTM D638/03) | |
| Izod impact | Izod impact resistance | Izod TMI Impactor |
| resistance | (ASTM D256/6(2010)) | No43-01 |
| Gardner | Gardner impact resistance | Gardner impact |
| impact | (ASTM D5420-10) | equipment |
| resistance | | |
| at 23° C. | | |
| Injection for | Injection Molding of Test | Injector Arburg 370c |
| determination | Specimens (ASTM D- | 800 250 Selogica |
| of physical | 4101-06) | |
| properties | | |
| HDT | Standard test method for | Tinius Olsen |
| | temperature deflection of | Microprocessor - |
| | plastics under bending load | Controlled Automatic |
| | in edge position (ASTM | Deflection Temperature |
| | D648). | Tester With DS -5 |
| | | Data and Control System. |
| Vicat | Standard test method for | Tinius Olsen |
| | Vicat softening temperature | Microprocessor - |
| | of plastics (ASTM D1525) | Controlled Automatic |
| | | Deflection Temperature |
| | | Tester With DS -5 |
| | | Data and Control |
| | | System. |

The test results are shown in Tables 5 and 6 for the mixtures made with the polypropylene and polyethylene-based impact modifiers, respectively.

TABLE 5
Mechanical features of polypropylene/ethylene random copolymer-
based resins with polypropylene based impact modifier.

| | | | | Tensile | | Bending | Izod | Gardner |
|---|---|---|---|---|---|---|---|---|
| | | | | modulus of | 1% Secant | elasticity | impact | impact |
| | Melt | Tensile | Deformation | elasticity | modulus | modulus | 23° C. | 23° C. |
| Sample | Flow | (MPa) | (%) | (MPa) | (MPa) | (MPa) | (J/m) | (J) |
| A₁ | 6.52 | 25.8 | 12.1 | 1292.8 | 909.0 | 958.4 | 240.5 | 36.1 |
| A₂ | 5.82 | 25.0 | 12.3 | 1183.9 | 873.1 | 917.5 | 308.0 | 35.0 |
| A₃ | 5.42 | 24.0 | 15.5 | 1056.7 | 831.2 | 869.8 | 386.7 | 33.7 |
| A₄ | 2.97 | 23.5 | 17.8 | 1002.2 | 813.3 | 849.3 | 420.5 | 33.2 |
| A₅ | 3.07 | 22.8 | 23.0 | 911.4 | 783.4 | 815.2 | 476.7 | 32.4 |

TABLE 6
Mechanical features of polypropylene/ethylene random copolymer-
based resins with impact modifier base polyethylene.

| | | | | Tensile | | Bending | Izod | Gardner |
|---|---|---|---|---|---|---|---|---|
| | | | | modulus of | 1% Secant | elasticity | impact | impact |
| | Melt | Tensile | Deformation | elasticity | modulus | modulus | 23° C. | 23° C. |
| Sample | Flow | (MPa) | (%) | (MPa) | (MPa) | (MPa) | (J/m) | (J) |
| B₁ | 6.01 | 24.3 | 13.1 | 1247.7 | 840.3 | 892.3 | 177.6 | 35.6 |
| B₂ | 5.02 | 23.5 | 13.3 | 1142.5 | 807.1 | 854.2 | 227.5 | 34.5 |
| B₃ | 2.52 | 22.6 | 16.7 | 1019.8 | 768.4 | 809.8 | 285.6 | 33.3 |
| B₄ | 7.85 | 22.1 | 19.2 | 967.2 | 751.8 | 790.7 | 310.5 | 32.8 |
| B₅ | 5.26 | 21.5 | 24.8 | 879.6 | 724.2 | 759.0 | 352.1 | 31.9 |

The results show that in both propylene/ethylene resins with polypropylene or polyethylene-based impact modifier there is a decrease in stiffness expressed in elastic modulus and secant modulus as the percentage of impact modifier is increased. The Izod impact is improved as this percentage of impact modifier is increased in both cases. However, better results are observed in the case of the polypropylene based impact modifier due to miscibility by similar structure. The Gardner impact suffers a slight reduction as the percentage of impact modifier is increased.

According to the test results shown in Tables 5 and 6 and with the objective of testing the resin properties in the manufacture of container caps, polypropylene resins comprising propylene/ethylene copolymer, additives, and propylene/butylene impact modifier elastomer (1% to 8% impact modifier) were prepared. The prepared resins C₁ through C₅ are described in detail in Table 7.

TABLE 7
Polypropylene/ethylene random copolymer-based resins with
polypropylene based impact modifier, with narrower range.

| | | FORMULATION (% w/w) | | | | |
|---|---|---|---|---|---|---|
| | COMPONENT | C₁ | C₂ | C₃ | C₄ | C₅ |
| Polypropylene | Propylene/ethylene random | 97.82 | 95.82 | 92.82 | 94.82 | 91.82 |
| resin | copolymer | | | | | |
| Impact | Propylene/butylene elastomer | 1.00 | 3.00 | 6.00 | 4.00 | 7.00 |
| modifier | | | | | | |
| Primary | Tris (4-tert-butyl-3-hydroxy-2,6- | 0.02 | 0.02 | 0.02 | 0.02 | 0.02 |
| antioxidant | dimethylbenzyl) isocyanurate | | | | | |
| Secondary | Tris (2,4-di-di-tert-butylphenyl) | 0.04 | 0.04 | 0.04 | 0.04 | 0.04 |
| antioxidant | phosphite | | | | | |
| Nucleating | Sodium benzoate | 0.2 | 0.2 | 0.2 | 0.2 | 0.2 |
| Acid acceptor. | Magnesium aluminum hydroxide | 0.03 | 0.03 | 0.03 | 0.03 | 0.03 |
| | carbonate | | | | | |
| Release agent | Oleamide | 0.03 | 0.03 | 0.03 | 0.03 | 0.03 |
| Release agent | cis-13-docosenoamide | 0.66 | 0.66 | 0.66 | 0.66 | 0.66 |
| Antistatic | Glyceryl monostearate | 0.20 | 0.20 | 0.20 | 0.20 | 0.20 |

The resins C₁ to C₅ were characterized for their HDT and Vicat thermal properties and mechanical features. The test results are shown in Tables 8 and 9.

TABLE 8
Mechanical features of polypropylene/ethylene random copolymer-
based resins with polypropylene based impact modifier.

| | | | | Tensile | | Bending | Izod | Gardner |
|---|---|---|---|---|---|---|---|---|
| | | | | modulus of | 1% Secant | elasticity | impact | impact |
| | Melt | Tensile | Deformation | elasticity | modulus | modulus | 23° C. | 23° C. |
| Sample | Flow | (MPa) | (%) | (MPa) | (MPa) | (MPa) | (J/m) | (J) |
| C₁ | 3.51 | 26.1 | 12.4 | 1233.9 | 920.7 | 976.6 | 243.9 | 37.1 |
| C₂ | 4.79 | 25.4 | 11.8 | 1283.7 | 903.3 | 955.5 | 226.3 | 35.3 |
| C₃ | 4.42 | 25.4 | 12.2 | 1249.4 | 869.5 | 909.4 | 278.1 | 37.1 |
| C₄ | 3.47 | 24.8 | 12.5 | 1112.7 | 876.8 | 926.0 | 331.0 | 34.4 |
| C₅ | 4.07 | 25.6 | 11.9 | 1340.9 | 894.4 | 933.3 | 273.8 | 34.4 |

TABLE 9
HDT and Vicat features of polypropylene/ethylene random copolymer-
based resins with polypropylene-based impact modifier.

HDT ° C.

| FORMULATION | Vicat ° C. | 0.45 MPa | 1.82 MPa |
|---|---|---|---|
| C₁ | 122.7 | 92.6 | 77.8 |
| | 125.2 | 94.7 | 78.2 |
| Average | 124.0 | 93.7 | 78.0 |
| C₂ | 122.1 | 77.4 | 60.8 |
| | 123.4 | 80.9 | 58.4 |
| Average | 122.75 | 79.2 | 59.6 |
| C₃ | 122.5 | 79.8 | 68.7 |
| | 124.4 | 80.9 | 68.7 |
| Average | 123.45 | 80.4 | 68.7 |
| C₄ | 121.1 | 80.3 | 73.7 |
| | 124.1 | 79.8 | 73.2 |
| Average | 122.6 | 80.1 | 73.45 |
| C₅ | 124.3 | 85.0 | 77.1 |
| | 125.4 | 83.9 | 78.4 |
| Average | 124.85 | 84.5 | 77.75 |

These tests allow finding properties much closer to those required as stiffness/impact balance, so that the resins C₁ to C₅ are candidates to be tested in the application of linerless caps. The results obtained confirm that the softening temperatures of the resins of the present disclosure in all cases are higher than 120° C., a value required for the material to have sufficient strength in case of temperature increases in the packaging or in the transport of packaged materials.

### Example 4: Manufacturing and Characterization of Linerless Type Caps with Polypropylene/Ethylene Random Copolymer-Based Resins

Linerless caps were manufactured from propylene/ethylene random copolymer-based resins as described in formulations C₂, C₃ and C₄ in Table 7 by injection molding method.

Dimensional and functional measurements were carried out on these caps to verify their performance compared to caps made of high-density polyethylene (HDPE). The results of the dimensional tests for the linerless (white) caps are shown in Table 10.

TABLE 10
Dimensional and functional tests on white linerless caps.

| | SPECIFICATION | | | | | | | | |
|---|---|---|---|---|---|---|---|---|---|
| | | Outside | Boreseal | | | Closing | | Removal | SST/0.69- |
| | Diameter | diameter | diameter | Height | Weight | torque | Application | torque | 1.03-1.21 |
| Sample | E (mm) | (mm) | (mm) | (mm) | (gr) | (J) | angle (°) | (J) | (MPa) |
| C₂ | 25.80 | 29.5 | 22.52 | 15.90 | 2.18 | 1.356 | 780 | 1.243 | |
| | 25.80 | 29.51 | 22.56 | 15.95 | 2.19 | 1.356 | 770 | 1.469 | |
| average | 25.80 | 29.51 | 22.54 | 15.93 | 2.19 | 1.356 | 775 | 1.356 | Complies |
| C₃ | 25.80 | 29.52 | 22.48 | 15.86 | 2.19 | 1.356 | 750 | 1.243 | |
| | 25.85 | 29.45 | 22.47 | 15.90 | 2.18 | 1.356 | 760 | 1.356 | |
| average | 25.83 | 29.52 | 22.48 | 15.88 | 2.19 | 1.356 | 755 | 1.356 | Complies |
| C₄ | 25.85 | 29.50 | 22.52 | 15.89 | 2.16 | 1.356 | 770 | 1.469 | |
| | 25.90 | 29.49 | 22.50 | 15.90 | 2.13 | 1.356 | 770 | 1.356 | |
| average | 25.88 | 29.50 | 22.51 | 15.90 | 2.15 | 1.356 | 770 | 1.469 | Complies |
| HDPE | 25.90 | 29.70 | 22.59 | 16.07 | 2.52 | 1.356 | 730 | 0.904 | |
| (commercial) | 25.90 | 29.69 | 22.58 | 16.08 | 2.49 | 1.356 | 730 | 1.243 | |
| average | 25.90 | 29.70 | 22.59 | 16.08 | 2.51 | 1.356 | 730 | 1.130 | Complies |

All three (3) resins tested met the standards of all dimensional and performance variables normally required for this type of application, which demonstrates the functionality of the resins of the present disclosure. However, one of the obvious advantages of the resins of the present disclosure over conventional resins is that the weight of the caps made from the polypropylene resins of the present invention is much less than HDPE caps. For example, formulations C₂ and C₃ are 13% lighter than HDPE (commercial) caps, while formulation C₄ is 14% lighter as seen in FIG. 1. This is achieved due to the higher stiffness of polypropylene when compared to HDPE.

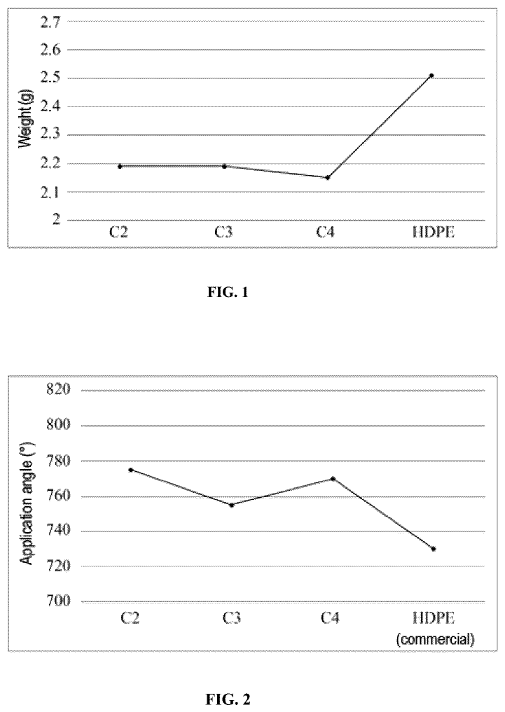

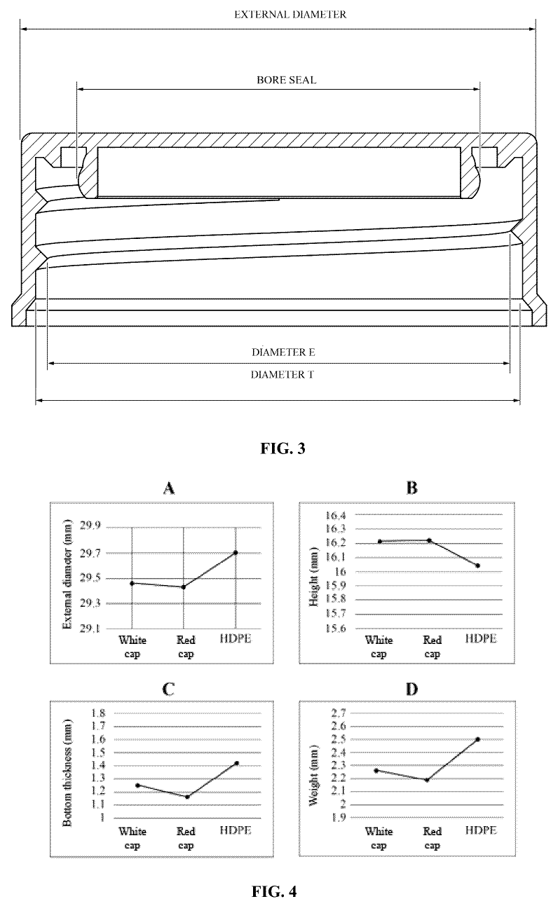

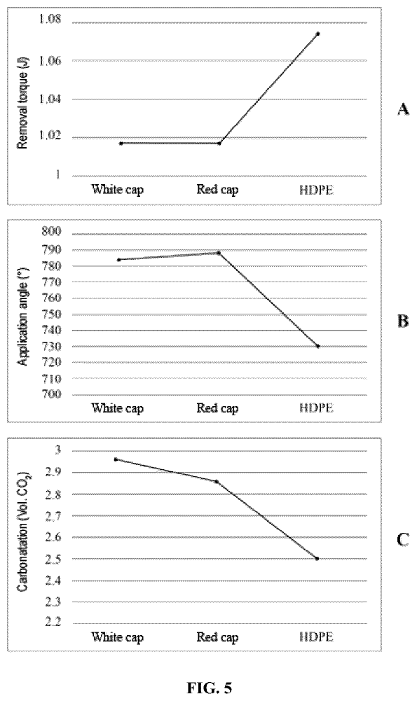

On the other hand, although the angle of application of all the caps used is within the admissible range, formulation C₃ presents a value more similar to that of HDPE as shown in FIG. 2. In addition, all the formulations used pass the pressure test performed at 0.69 MPa, 1.03 MPa and 1.21 MPa, standard values of these tests, which demonstrates the excellent performance in tightness of the caps in the container manufactured with resins of the present disclosure.

On the other hand, tests were carried out by adding different pigments to the resins in order to evaluate the effect of their incorporation in the final properties of the caps manufactured with the resins of the present disclosure. Table 11 shows the summary of the results of the tests carried out on red linerless caps obtained with C₄ resin in terms of their dimensional features according to the parameters of FIG. 3.

TABLE 11
Dimensional values of red linerless short caps.

| | | | | | Outside | Bottom |
|---|---|---|---|---|---|---|
| | Height | Weight | Diameter | Diameter | diameter | thickness |
| Sample | (mm) | (gr) | E (mm) | T (mm) | (mm) | (mm) |
| Minimum | 16.19 | 2.19 | 25.75 | 27.33 | 29.40 | 1.15 |
| Maximum | 16.23 | 2.20 | 25.85 | 27.56 | 29.47 | 1.18 |
| Average | 16.22 | 2.19 | 25.79 | 27.47 | 29.43 | 1.16 |

From the group of caps manufactured and evaluated in the Table, a group of 3 caps was randomly selected to pressure test closed containers with these caps at the established standard pressures: 0.69 MPa, 1.03 MPa and 1.21 MPa, with the results shown in Table 12.

TABLE 12
Internal pressure tests for red caps performed in quadruplicate.

| | Condition | | Condition | | Condition | | | |
|---|---|---|---|---|---|---|---|---|
| | (0.69 MPa-1 min) | | (1.03 MPa-1 min) | | (1.21 MPa-1 min) | | | |
| | | Does not | | Does not | | Does not | Status | |
| Sample | Complies | comply | Complies | comply | Complies | comply | Approved | Rejected |
| 1 | X | | X | | X | | X | |
| 2 | X | | X | | X | | X | |
| 3 | X | | X | | X | | X | |

The results of the dimensionality and functionality tests of the red linerless caps manufactured by injection with the C₄ resin show favorable results for the service in the container used, even at high pressure. These results indicate that the resins of the development can be used in the manufacture of caps for carbonated beverage containers such as soft drinks, including transportation stages to hot areas where, due to the high ambient temperatures, an increase in the pressure of the bottled liquid will be generated, requiring a higher performance against the hermeticity achieved between the container and the cap, avoiding losses due to containment.

In addition, white linerless caps were also manufactured and were subjected to the same dimensionality and functionality tests carried out on the red caps. Tables 13 and 14 show the results of the tests carried out on white linerless caps obtained with C₄ resin.

TABLE 13
Dimensional values of white linerless caps made on 20 samples.

| | | | | | Outside | Bottom |
|---|---|---|---|---|---|---|
| | Height | Weight | Diameter | Diameter | diameter | thickness |
| Sample | (mm) | (gr) | E (mm) | T (mm) | (mm) | (mm) |
| Minimum | 16.19 | 2.23 | 25.80 | 27.43 | 29.40 | 1.23 |
| Maximum | 16.25 | 2.29 | 25.85 | 27.59 | 29.52 | 1.28 |
| Average | 16.21 | 2.26 | 25.82 | 27.51 | 29.46 | 1.25 |

TABLE 14
Internal pressure tests for white caps performed in quadruplicate.

| | Condition | | Condition | | Condition | | | |
|---|---|---|---|---|---|---|---|---|
| | (0.63 MPa-1 min) | | (1.03 MPa-1 min) | | (1.21 MPa-1 min) | | | |
| | | Does not | | Does not | | Does not | Status | |
| Sample | Complies | comply | Complies | comply | Complies | comply | Approved | Rejected |
| 1 | X | | X | | X | | X | |
| 2 | X | | X | | X | | X | |
| 3 | X | | X | | X | | X | |

Observations: There was no leakage in any of the tested caps.

The results of the dimensionality and functionality tests of linerless caps with white pigment manufactured by injection with C₄ resin show that the expected results are achieved, even in high-pressure containment tests. For this reason, these caps could be used for the packaging of non-carbonated and carbonated beverages, which, as previously explained, require adequate performance in hot climates.

The comparison of the red and white caps shows that, although there are small differences in the weight and thickness of the caps, which could be a consequence of the incorporation of the pigments on the final density of the resin, the properties of the resins with which the caps were manufactured are within the established ranges of conformity for this type of application.

### Example 5. Comparative Analysis of Linerless Caps with Polypropylene/Ethylene Random Copolymer-Based Resins

For the comparison of the behavior of white and red caps, dimensional, functional and carbonatation tests were carried out to verify CO₂ retention volume over time. The results are shown in Tables 15 and 16.

TABLE 15
Dimensional tests on white caps and red caps.

| | Polypropylene/ | | Polypropylene/ | | HDPE | |
|---|---|---|---|---|---|---|
| Dimensional test | ethylene white cap | | ethylene red cap | | cap | |
| Outside Diameter | 29.46 | mm | 29.43 | mm | 29.70 | mm |
| Diameter T | 27.51 | mm | 27.47 | mm | 27.50 | mm |
| Diameter E | 25.82 | mm | 25.79 | mm | 25.90 | mm |
| Height | 16.21 | mm | 16.22 | mm | 16.08 | mm |
| Bottom Thickness | 1.25 | mm | 1.16 | mm | 1.42 | mm |
| Weight | 2.26 | g | 2.19 | g | 2.50 | gr |

The results for the cap diameter and height measurements are generally within the required specifications. Although the bottom thickness and weight are below the lower limit of the specification, this reduction is important in reducing the final weight of the caps. This behavior is mainly generated by the decrease in bottom thickness and the difference between the density of the materials (HDPE 0.952 g/cm³ vs polypropylene/ethylene resin 0.92 g/cm³).

TABLE 16
Functional tests on white caps and red caps.

| | Polypropylene/ | | Polypropylene/ | | | |
|---|---|---|---|---|---|---|
| Functional | ethylene white | | ethylene red | | HDPE | |
| test | cap | | cap | | cap | |
| Removal | 1.017 | J | 1.017 | J | 1.074 | J |
| Torque | | | | | | |
| Application | 784° | | 788° | | 730° | |
| Angle | | | | | | |
| Tamper | Complies | | Complies | | Complies | |
| Evident | | | | | | |
| Tightness | No Leakage | | No Leakage | | No Leakage | |
| SST | | | | | | |
| Carbonatation | 2.96 | Vol CO₂ | 2.86 | Vol CO₂ | 2.5 | Vol CO₂ |

Finally, the results of the functional tests show that with the caps made with the resins of the present invention all the specifications are met, and the addition of the pigments does not influence the final properties of the resin. Particularly, in comparison with the commercial resin in the removal torque, a slight decrease in the force required to open the cap is observed. In addition, an adequate and easy breakage of the cap bridges is observed, and the band remains in the container (Tamper Evident). The carbonatation tests show that the caps manufactured with the resins of the present disclosure, present values above the minimum specification, which confirms the excellent properties of the resins, e.g., in the manufacture of caps for certain applications.

In general, the results of the previously described Examples demonstrate the enormous versatility to be achieved from the proper balance of components of the resins in this disclosure, where the functionality and performance properties of the resins can be adjusted according to the requirements demanded for each desired application.

1. A polypropylene resin comprising propylene/ethylene copolymer between 85% w/w to 99% w/w; elastomer as impact modifier based on polypropylene or polyethylene between 0.2% w/w to 14% w/w; and additives between 1% w/w to 2% w/w.

2. The polypropylene resin according to claim 1, wherein in the copolymer the ratio of propylene to ethylene is between 15.7:1 to 49:1.

3. The polypropylene resin of claim 1, wherein the propylene/ethylene copolymer is a random copolymer.

4. The polypropylene resin according to claim 1, wherein the polypropylene-based impact-modifying elastomer is a copolymer of propylene and butylene.

5. The polypropylene resin according to claim 4, wherein the polypropylene-based impact-modifying elastomer has a propylene to butylene ratio of 1.5:1 to 49:1.

6. The polypropylene resin according to claim 1, wherein the polyethylene-based impact-modifying elastomer is a copolymer of ethylene and butylene.

7. The polypropylene resin according to claim 6, wherein the polyethylene-based impact modifier has an ethylene to butylene ratio of 4:1 to 49:1.

8. The polypropylene resin according to claim 1, wherein the ratio of the propylene/ethylene copolymer to the polypropylene or polyethylene-based impact-modifying elastomer is between 6.1:1 to 98:1.

9. The polypropylene resin according to claim 1, wherein the additives are selected from antioxidants, acid acceptors, release agents, antistatic, nucleating agents, or mixtures thereof.

10. The polypropylene resin according to claim 1 characterized in that:
the melt flow rate is between 2 g/10 min to 10 g/10 min measured at 230° C.;
density between 0.89 kg/m³ and 0.91 kg/m³;
elongation between 11% and 15%;
flexural modulus between 792.9 MPa to 1034.2 MPa;
tensile strength between 24.13 MPa and 27.58 MPa;
Izod impact between 210 J/m and 350 J/m.
